(19) United States
(12) Patent Application Publication
(10) Pub. No.: US 2025/0124708 A1
(43) Pub. Date: Apr. 17, 2025

(54) VIDEO-TEXT MODELING WITH ZERO-SHOT TRANSFER FROM CONTRASTIVE CAPTIONERS

(71) Applicant: Google LLC, Mountain View, CA (US)

(72) Inventors: Shen Yan, Seattle, WA (US); Tao Zhu, Los Altos, CA (US); Zirui Wang, Mountain View, CA (US); Yuan Cao, Mountain View, CA (US); Jiahui Yu, Seattle, WA (US)

(21) Appl. No.: 18/694,604

(22) PCT Filed: Dec. 8, 2023
(86) PCT No.: PCT/US2023/083125

§ 371 Date: Mar. 22, 2024

Related U.S. Application Data
(60) Provisional application No. 63/431,224, filed on Dec. 8, 2022.

(51) Int. Cl. G06V 20/40; G06F 16/583

(52) U.S. Cl. CPC G06V 20/41; G06F 16/583

(57) ABSTRACT

Provided is an efficient approach to establish a foundational video-text model for tasks including open-vocabulary video classification, text-to-video retrieval, video captioning and video question-answering. Some example implementations include a model which can be referred to as VideoCoCa. Example implementations reuse a pretrained image-text contrastive captioner (CoCa) model and adapt it to video-text tasks with little or minimal extra training. While previous works adapt image-text models with various cross-frame fusion modules (for example, cross-frame attention layer or perceiver resampler) and finetune the modified architecture on video-text data, aspects of the present disclosure leverage findings that the generative attentional pooling and contrastive attentional pooling layers in the image-text CoCa design are instantly adaptable to “flattened frame embeddings”, yielding a strong zero-shot transfer baseline for many video-text tasks.

### RELATED APPLICATIONS

This application claims priority to and the benefit of U.S. Provisional Patent Application No. 63/431,224, filed Dec. 8, 2022. U.S. Provisional Patent Application No. 63/431,224 is hereby incorporated by reference in its entirety.

### FIELD

The present disclosure relates generally to machine learning models. More particularly, the present disclosure relates to the application of a pre-trained image-text processing model to video understanding tasks.

### BACKGROUND

The field of video understanding, which includes tasks such as video classification, video question answering, video retrieval, and video captioning, has seen significant advancements in recent years due to the development of innovative computational models.

However, a significant challenge in this domain is the computational resources required for both the initial training of the model and the subsequent fine-tuning of the model for specific tasks. Each time a model is trained or fine-tuned, a vast amount of computational resources are consumed. This is especially the case when the model involves a large number of parameters.

Furthermore, when the model is applied to a new type of task or data, such as video data, additional parameters are often added to the model and then these additional parameters are trained from scratch. This further increases the computational resources required for training the model.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method for performing a video understanding task with improved computational efficiency. The method includes accessing, by a computing system comprising one or more computing devices, a pre-trained image-text processing model, wherein the pre-trained image-text processing model comprises one or more pre-trained attentional pooling layers having a number of parameters, and wherein the pre-trained image-text processing model has been pre-trained on a joint contrastive and generative image captioning loss function. The method includes obtaining, by the computing system, an input video that comprises a plurality of image frames. The method includes processing, by the computing system, the input video with the pre-trained image-text processing model having the one or more pre-trained attentional pooling layers having the same number of parameters to generate, as an output of the pre-trained image-text processing model, a prediction for the video understanding task. The method includes providing, by the computing system, the prediction for the video understanding task as an output.

Another example aspect of the present disclosure is directed to one or more non-transitory computer-readable media that collectively store: a pre-trained image-text processing model, wherein the pre-trained image-text processing model comprises one or more pre-trained attentional pooling layers having a number of parameters, and wherein the pre-trained image-text processing model has been pre-trained on a joint contrastive and generative image captioning loss function; and computer-executable instructions for perform operations, the operations comprising processing, by the computing system, an input video comprising a plurality of image frames with the pre-trained image-text processing model having the one or more pre-trained attentional pooling layers having the same number of parameters to generate, as an output of the pre-trained image-text processing model, a prediction for a video understanding task.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example video-text model according to example embodiments of the present disclosure.

FIG. 2 depicts a graphical diagram of an example attentional poolers and flattened frame token embeddings according to example embodiments of the present disclosure.

FIG. 3 depicts a flow chart diagram of an example method to use of pre-trained image-text processing model to perform a video understanding task according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

Aspects of the present disclosure provide an efficient approach to establish a foundational video-text model for various video understanding tasks such as open-vocabulary video classification, text-to-video retrieval, video captioning, and video question-answering. In particular, some example implementations can reuse a pretrained image-text model, for example the contrastive captioner (CoCa) model, and adapt it to video-text tasks with zero or minimal additional training. Example implementations of the proposed approach which repurpose the contrastive captioner (CoCa) model for video tasks can be referred to as VideoCoCa.

In particular, certain previous works seek to adapt image-text models by modifying the image-text model to include various cross-frame fusion modules (for example, a cross-frame attention layer or the perceiver resampler) or other novel layers or architectural aspects. After modifying the model architecture, these previous works then train the newly added parameters on video-text data. Re-training new sets of parameters in this fashion increases the computational resources required for adapting the model for video tasks.

In contrast, example implementations of the present disclosure instead directly adapt a pre-trained image-text model to video tasks. Specifically, as one example, a frozen image encoder of a pretrained image-text CoCa can be used to separately process each video frame of an input video so as to generate N token embeddings per frame for T video frames. Some example implementations can then flatten the N×T token embeddings as a long sequence of frozen video representations and apply CoCa's generative and contrastive attentional pooling layers to this representation to generate a prediction for a video task.

In some example implementations, all of the model weights including the attentional pooling layers can be directly loaded from a pre-trained image-text CoCa model, while still achieving state-of-the-art performance on video understanding tasks. Additional example implementations can perform various forms of light-weight finetuning on top of the image-text model to provide even further performance gains.

More particularly, one example aspect of the present disclosure is directed to systems and methods for performing a video understanding task with improved computational efficiency. An example method leverages a pre-trained image-text processing model which has been pre-trained on a joint contrastive and generative image captioning loss function. One example of such a model is the Contrastive Captioners (CoCa) model described in Yu et al., CoCa: Contrastive Captioners are Image-Text Foundation Models, arXiv: 2205.01917. The image-text processing model can include one or more pre-trained attentional pooling layers with a number of parameters. The proposed method can include processing an input video, which includes multiple image frames, using this pre-trained model to generate a prediction for the video understanding task.

Specifically, the proposed technique can utilize a pre-trained image-text processing model that combines contrastive pretraining approaches with generative pretraining approaches. The image-text processing model can be designed to facilitate image, text, and image-text representation learning. The model can include a cascaded decoder design, where the bottom half unimodal decoder encodes the text context with causally masked self-attention, and the top half multimodal decoder uses cross-attention to align image and text. The model can be trained with joint contrastive loss and captioning loss.

Thus, in some implementations, the pre-trained image-text processing model includes a pre-trained unimodal image encoder. This encoder processes an input image to generate one or more frame embeddings. The pre-trained attentional pooling layers of the image-text processing model then process these frame embeddings to generate one or more contrastive embeddings and one or more generative embeddings. When using this model to process an input video, the method can include separately processing each of the image frames with the pre-trained unimodal image encoder to generate a plurality of frame embeddings.

According to an aspect of the present disclosure, in some implementations, the frame embeddings generated from processing the image frames of the input video are combined to form a set of combined frame embeddings. This can be achieved in several ways. For instance, the frame embeddings can be concatenated along a temporal dimension to generate a set of flattened frame embeddings. Alternatively, the frame embeddings can be reshaped into a joint space-time representation. The combined frame embeddings are then processed by the attentional layers of the model to generate one or more generative embeddings and one or more contrastive embeddings.

In some implementations, the parameters of the pre-trained attentional pooling layers of the pre-trained image-text processing model can be held fixed after the pre-training of the image-text processing model. This allows for the direct application of the model to video understanding tasks, including zero-shot video understanding tasks, without the need for further training.

However, other implementations of the present disclosure also provides for the further fine-tuning various portions of the image-text model, such as the parameters of the pre-trained attentional pooling layers of the pre-trained image-text processing model. This fine-tuning can be performed using the joint contrastive and generative image captioning loss function applied to video data. The fine-tuning can involve unfreezing all parameters of the pre-trained image-text processing model, or it can involve freezing the parameters of the encoder and decoder while only tuning the parameters of the generative and contrastive poolers.

Some implementations of the present disclosure also allows for the addition of an extra encoder model to the attentional pooling layers before processing the input video. This extra encoder model can be a Transformer encoder that models interactions between tokens from different frames. The output tokens from this encoder can then be used for the captioning loss, and their global average pooled embeddings over the temporal dimension can be used for the contrastive loss.

The proposed approach can be applied to various video understanding tasks. For instance, it can be used for a video classification task, where the goal is to categorize the input video into one of several predefined categories. The method can also be used for a video question answering task, where the goal is to generate an answer to a question about the content of the input video. Additionally, the method can be used for a video captioning task, where the goal is to generate a textual description of the content of the input video.

The systems and methods of the present disclosure provide a number of technical effects and benefits. As one example, the proposed techniques address the technical problem of computational resource consumption in video understanding tasks. In particular, the proposed techniques, which leverage a pre-trained image-text processing model, significantly reduce the computational resources necessary for such tasks. This is achieved by reusing the parameters of the pre-trained image-text processing model, without requiring the addition of new parameters or extensive re-training.

In particular, some example implementations allow for the parameters of the pre-trained attentional pooling layers to be held fixed after the pre-training of the image-text processing model, enabling the direct application of the model to various video understanding tasks, including zero-shot video understanding tasks. This approach eliminates the need for further training, thereby significantly reducing computational resources. In other implementations, the proposed techniques enable the fine-tuning of the parameters of the pre-trained attentional pooling layers of the pre-trained image-text processing model, which can be performed using the joint contrastive and generative image captioning loss function applied to video data. This fine-tuning process still represents reduced computational consumption versus training of an entirely new model, as the pre-trained parameters represent a strong starting point from which the model can be finetuned.

An additional technical advantage of the present disclosure is the ability to leverage a video understanding model that doesn't necessitate training on voluminous and computationally intricate video data. Traditional approaches to video understanding often necessitated training on extensive video datasets, a process that is both computationally costly and time-consuming due to the high dimensionality and complexity of video data. The proposed approach, however, overcomes this barrier by training solely on image data while retaining the capacity to execute video understanding tasks.

The technology described herein can be used to perform various video understanding tasks. One such task is video classification. In this task, a specific input data could be an unclassified video from a media library, and the output data could be a category label that accurately describes the video content, thus enabling organized storage and retrieval.

Another task to which this technology is applicable is video question answering. In this scenario, the input data could be a video and a specific question about the video content, such as “what is the main action in the video?”. The output data could be a precise answer to the asked question, for example enhancing interactive learning experiences in educational settings.

Additionally, the technology can also be used for video captioning tasks. For this task, a specific input data could be a video without any textual description. The output data generated by the technology could be a detailed textual description of the video content, for example providing accessibility benefits such as aiding the hearing impaired by providing captions.

In the field of robotics, the technology can interpret video inputs to comprehend and navigate the robot's environment. Here, the input data can be a real-time video stream capturing the robot's surroundings, and the output data could be a set of instructions for the robot to navigate its environment safely and efficiently.

As another example, the technology can also be used to perform video retrieval based on textual queries. In this case, the input data could be a specific textual query, and the output data could be a list of videos that match the query, thus improving search efficiency in information retrieval tools.

### Example Video Processing Models

### Example Image—Text Processing Model

Thus subsection describes one example image-text processing model. Other image-text processing models exist and can be used in accordance with the techniques described herein.

Contrastive Captioners (CoCa) is an encoder-decoder architecture that combines contrastive pretraining approaches with generative pretraining approaches. It is designed to facilitate image, text and image-text representation learning. CoCa adopts a cascaded decoder design, where the bottom half unimodal decoder encodes the text context with causally masked self-attention, and the top half multimodal decoder uses cross-attention to align image and text. The model is trained with joint contrastive loss and captioning loss. For text representations, the [CLS] token from the unimodal decoder is used as a global text representation for the contrastive loss, and the captioning loss is applied per text token to learn fine-grained visual-textual information.

CoCa uses two attentional pooling layers (poolers in short) to extract image representations, in which a n_{query}=256 generative attentional pooling layer is used to generate embeddings for captioning loss, and a n_{query}=1 contrastive attentional pooling layer together with its outputs as contrastive image embedding. The benefit of such an architecture design is two-fold. First, the pooler yields a fixed number of tokens (for example 256 tokens as generative embedding and 1 token as contrastive embedding) regardless of input image resolutions, making the image encoder and the text decoder more modular and adaptable to other modalities. Second, the pooler serves as a lightweight adaptor so that the pretrained ViT as backbone remains frozen for many downstream tasks. For example, it is shown that by only finetuning the poolers, a pretrained CoCa can already achieve 90.6% top-1 ImageNet accuracy, in which case the frozen ViT did not see any ImageNet data. Example implementations of the present disclosure adopt this design and adapt it to the video-text domain.

### Example Techniques for Transferring a Pre-Trained Model to Video-Text Tasks

This subsection describes how an example image CoCa model can be quickly turned into a VideoCoCa model by tuning a small portion of parameters. An input minibatch of videos can be denoted as V∈ [symbol] ^{B×T×H×W×C}, where T is the number of frames uniformly sampled from a video. Some example implementations extract tokens from images by partitioning an image into non-overlapping patches and linearly projecting them. All tokens can then be concatenated together to form a sequence, resulting in a minibatch of the sequence tokens \tilde{z} of shape [symbol] ^{(B×T)×N×d}, where

$$N = \frac{H}{h} \times \frac{W}{w} .$$

A positional embedding p∈ [symbol] ^{N×d} can be added to this sequence to obtain z. Some example implementations also extract text representations using a text decoder. The frame-level representations z^{L}∈ [symbol] ^{(B×T)×N×d} can be obtained by forwarding z into the image encoder, where L is the number of encoder layers.

There are various approaches that are possible to adapt CoCa to videos. Some example approaches are described in the paragraphs below.

### Attentional Poolers.

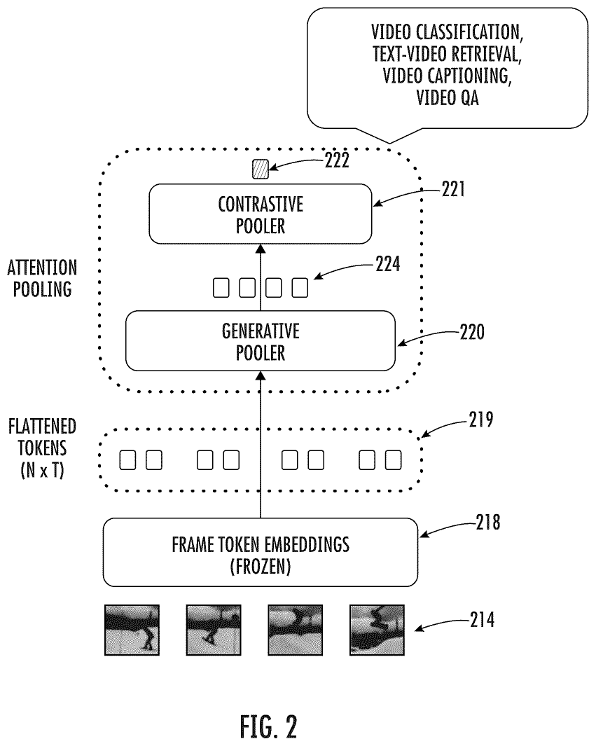

To obtain video representations, some example implementations concatenate all spatial tokens together along the temporal dimension into z^{L}∈ [symbol] ^{B×(T×N)×d}, which is then fed into the generative and the contrastive poolers. See FIG. 2 for a detailed illustration. This model corresponds to a late fusion of temporal information, similar to the factorized encoder. Compared to an alternative approach where additional new poolers are added on top of the frame-level representations to learn video representations, the model described in this paragraph does not add any novel learnable layers, allowing reuse of all parameters from the pretrained CoCa model with minimal extra computation, thereby enabling zero-shot transfer to video-text tasks from image-text models.

### Factorized Encoder.

This adaption additionally adds a Transformer encoder on top of the contrastive pooler. The frame-level representations z^{L}, is first fed into the generative pooler and the contrastive pooler to get the spatial embeddings z^{L}^{ₛ}∈ [symbol] ^{(B×T)×d}. The spatial embeddings z^{L}^{ₛ} are then reshaped to into z^{L}^{ₛ}∈ [symbol] ^{B×T×d} and fed into a transformer encoder consisting of Lₜ layers to model interactions between tokens from different frames. The output tokens are used for the captioning loss and their global average pooled embeddings over the temporal dimension are used for the contrastive loss. Some example implementations can use Lₜ=4. Note that different from an alternative approach where the spatial embeddings are summarized by a prepended learnable class token z_{cls}∈ [symbol] ^{d}, some example implementations of the present disclosure can use the output of the contrastive pooler as representation.

### Joint Space-Time Encoder.

This adaptation can include the use of a spatio-temporal attention model or joint space-time model. Specifically, some example implementations can reshape the sequence tokens into \tilde{z}∈ [symbol] ^{B×(T×N)×d} and then add the positional embedding p∈ [symbol] ^{(T×N)×d} to obtain z. p can be initialized by temporally repeating the positional embedding from the pretrained image model. This allows the CoCa image encoder to encode pairwise interactions between all spatial-temporal tokens from the first layer. The spatial-temporal representations z^{L}, is then fed into the generative pooler and the contrastive pooler to get the final task-specific representations. This model adaption corresponds to an early fusion of temporal information and does not add any new learnable layers. However, it makes the self-attention computation in the encoder heavier due to the linearly increased number of tokens.

### Mean Pooling.

In this adaption, the frame-level representations z^{L}∈ [symbol] ^{(B×T)×N×d}, are simply separately average pooled over the temporal dimension after the attentional poolers. It ignores the temporal information.

### Example Model Visualizations

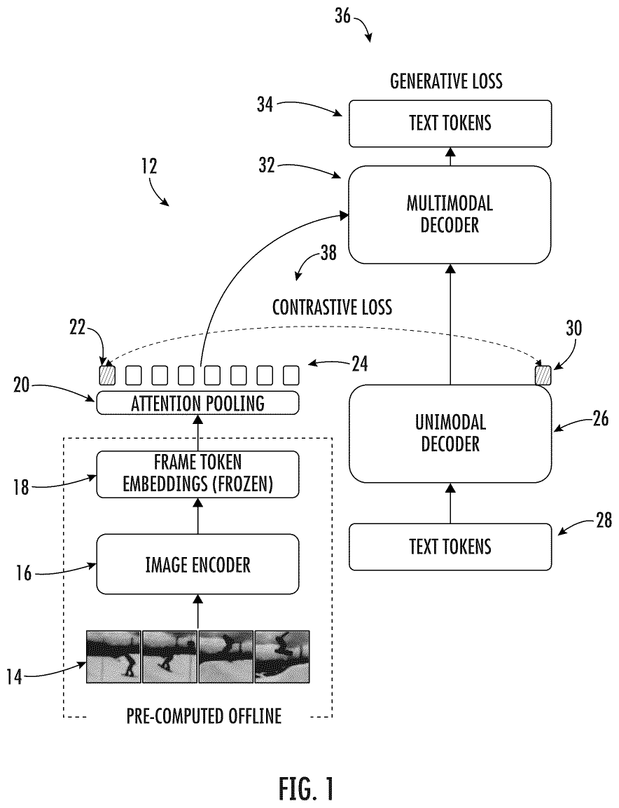

FIG. 1 shows an example framework for fine-tuning a pre-trained image-text model 12 to perform a video understanding task. A video can include a sequence or series of images (e.g., digital images) that, when displayed in rapid succession, create the illusion of motion. These images, also known as frames, can be captured or created in various ways, including through the use of digital cameras, computer graphics, or animation techniques. Each frame in a video can include pixel data, which collectively represent the visual information in the frame. Pixel data can include information about the color, brightness, and other visual attributes of each individual pixel in the frame. A video may also include audio data synchronized with the image data.

As illustrated in FIG. 1, an input video 14 is processed by a pre-trained image-text model 12, which is configured to perform the video understanding task. The input video 14 contains multiple image frames, and the image-text model 12 is pre-trained on an image-text dataset.

The pre-trained image-text model 12 comprises several components. One of the important components is a pre-trained unimodal image encoder 16. The unimodal image encoder 16 can process each of the image frames of the input video 14 individually to generate a plurality of frame embeddings 18. These frame embeddings 18 can represent the visual content of each frame in a latent space, capturing important visual features of the video.

The generated frame embeddings 18 are then processed by attentional pooling layers 20. These attentional pooling layers 20 further refine the frame embeddings 18 by focusing on the most salient features and discarding less relevant information. As a result, the attentional pooling layers 20 can generate two sets of embeddings: contrastive embeddings 22 and generative embeddings 24. The contrastive embeddings 22 can correspond to a general representation of the distinguishing features of the input video, while the generative embeddings 24 can be used to generate text descriptions or predictions about the video content.

In some implementations, the frame embeddings 18 can be combined to form a set of combined frame embeddings. This can be accomplished by concatenating the frame embeddings 18 along a temporal dimension. As a result, a set of flattened frame embeddings is generated, which represents the temporal sequence of frames in the video.

Taking into account an optional textual aspect of the model, the image-text processing model 12 also includes a unimodal text decoder 26. This component processes a set of input text tokens 28 and generates text embeddings. These text embeddings include a global text token 30 that serves as a comprehensive representation of the input text.

Further, the image-text processing model 12 incorporates a multimodal decoder 32. The multimodal decoder 32 processes both the generative embeddings 24 obtained from the attentional pooling layers 20 and the text embeddings obtained from the unimodal text decoder 26. The output of the multimodal decoder 32 is a set of text 34 that represents an output for a video understanding task.

Two types of loss function terms, generative loss term 36 and contrastive loss term 38, can be applied to the output of the image-text processing model 12. The generative loss term 36 is applied on the output set of text 34 generated by the multimodal decoder 32, for example aiming to minimize the difference between the generated text and the ground-truth text. The contrastive loss term 38 is applied between the contrastive embeddings 22 and the global text token 30. For example, the goal of the contrastive loss term 38 can be to bring the contrastive embeddings 22 and the global text token 30 closer in the latent space if the inputs are positive inputs associated with each other and push the contrastive embeddings 22 and the global text token 30 apart if the inputs are negative inputs that are not associated with each other.

In FIG. 2, the processing of an input video 214 is depicted. The input video 214, as shown in this figure, is a sequence of frames that contains important visual information. These frames are processed by a pre-trained unimodal image encoder (not explicitly depicted in FIG. 2), which is a component of the pre-trained image-text model mentioned in the previous description of FIG. 1. The unimodal image encoder processes each of the frames of the input video 214 to generate a set of frame token embeddings 218.

The frame token embeddings 218 represent the visual content of each frame in a latent space. These embeddings 218 capture visual features of the video, which can be further processed to extract more sophisticated representations. In this context, the frame token embeddings 218 are the building blocks for understanding the video content, as they serve as the primary input to the subsequent stages of processing.

The frame token embeddings 218 are then flattened into a set of N× T flattened tokens 219. This flattening process allows the model to represent the temporal sequence of frames in the video as a single, unified data structure. The flattened tokens 219 maintain the temporal order of the frames, thus preserving the temporal information contained in the video. The dimensionality of the flattened tokens 219, N×T, reflects the number of frames (T) in the video and the number of tokens (N) generated for each frame.

The flattened tokens 219 are then input to two attentional pooling layers: a generative pooling layer 220 and a contrastive pooling layer 221. These attentional pooling layers 220, 221 further process the flattened tokens 219, focusing on the most important features and discarding less relevant information.

The generative pooling layer 220 processes the flattened tokens 219 to generate a set of generative embeddings 224. These generative embeddings 224 can be used to generate text descriptions or predictions about the video content. The generation process is not explicitly depicted in FIG. 2, but it can be performed by a separate generative model (not shown), which can be part of the overall video understanding system.

The contrastive pooling layer 221 processes the flattened tokens 219 to generate a contrastive embedding 222. The contrastive embedding 222 is a general representation of the distinguishing features of the input video. It captures the unique aspects of the video that set it apart from other videos. The contrastive embedding 222 can be used to perform various video understanding tasks, such as video classification or video retrieval.

In some embodiments, the contrastive embedding 222 and/or the generative embeddings 224 can be used directly as the model output. In other embodiments, these embeddings 222, 224 can be further processed (for example, with additional feedforward layers and/or a softmax layer) to generate a model prediction for a video understanding task. This prediction can be a categorical label (for a video classification task), a textual description (for a video captioning task), an answer to a question (for a video question-answering task), or any other suitable form of prediction or output.

### Example Techniques for Finetuning on Video-Text Data

In addition to direct zero-shot transfer from image-text CoCa to video-text tasks, some example implementations can further push the limit of VideoCoCa by continued pretraining on web-scale video-text paired data. This subsection explores four different learning choices.

### Finetuning (FT).

Under this setup, the training system can unfreeze all parameters of the pretrained CoCa model during continued video-text pretraining, including the parameters of the encoder and the decoder, as well as the parameters of the generative pooler and the contrastive pooler. These parameters are finetuned together with the newly added learnable layers.

### Frozen Encoder-Decoder Tuning (Frozen).

In this approach, the training system can freeze the parameters of the encoder and the decoder, and only tune the parameters of the generative and the contrastive poolers. This allows the re-use of most parameters of the pretrained CoCa model.

Frozen Tuning then Finetuning (Frozen+FT).

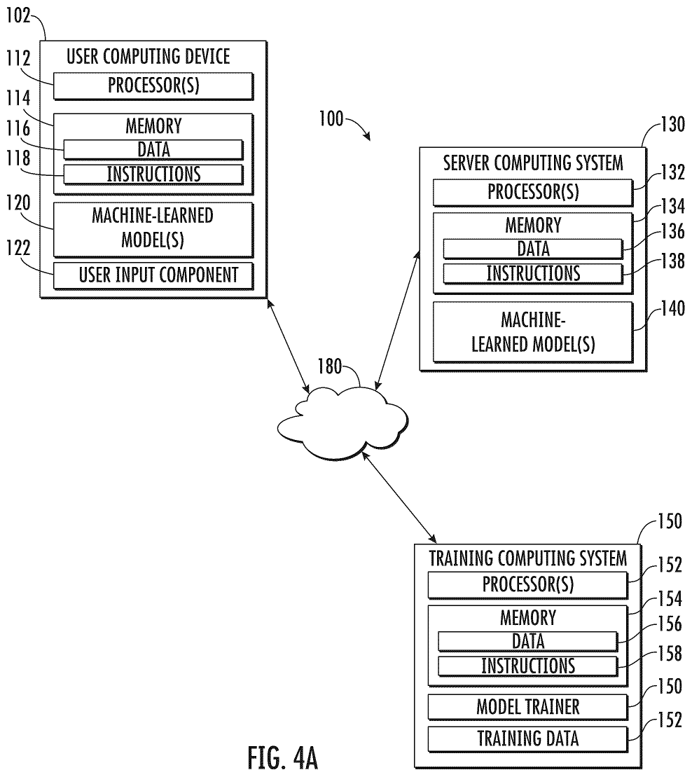

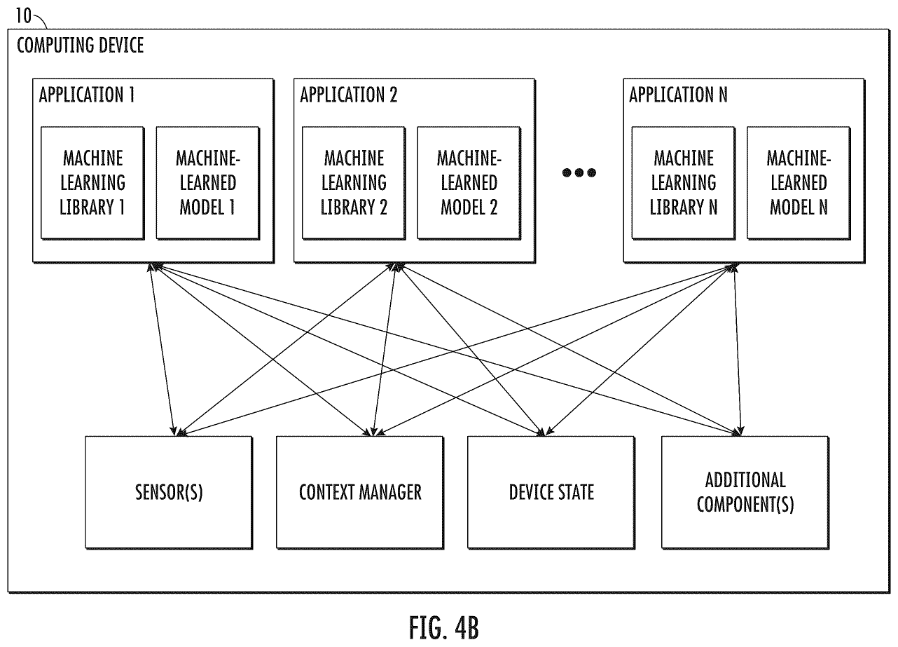

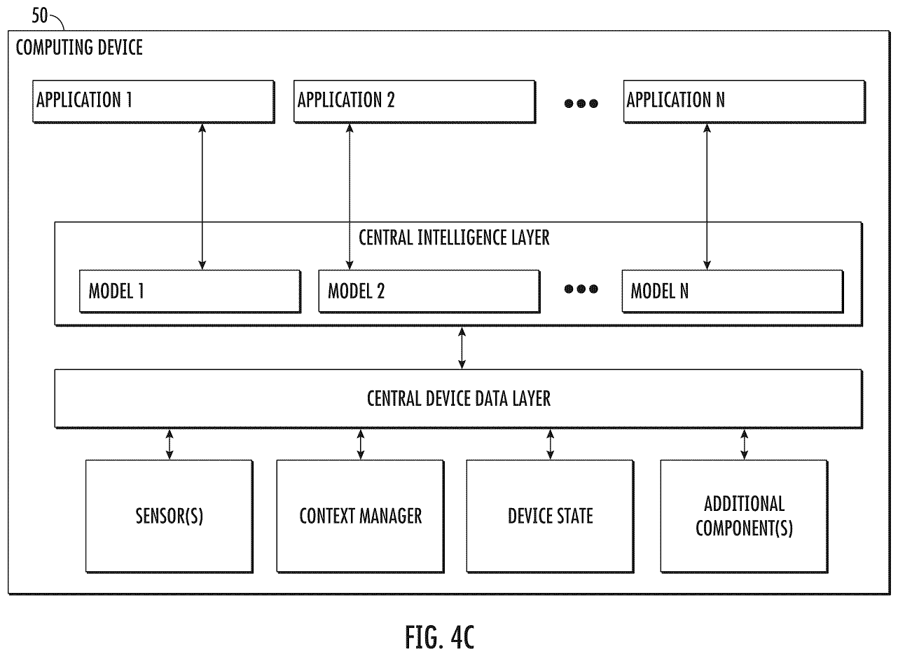

Frozen encoder-decoder tuning may converge very fast given the small amount of parameters of the pooler (See FIG. 4). Therefore, in this approach, the training system can first conduct frozen feature tuning and then finetuning. In this way, the parameters of the pooler can be quickly trained, thus making the finetuning more stable. Note that it is a two-step tuning method.

### Frozen Encoder Tuning (LIT).

In this example approach, only the parameters of the pretrained CoCa image encoder are frozen, and the parameters of the poolers are tuned as well as the decoder. As the computation of image representations is much heavier than text representations, this not only allows the training system to precompute frame-level embeddings once to save TPU memory and computations for development, but also provides sufficient amount of learnable parameters for task adaptation.

### Example Methods

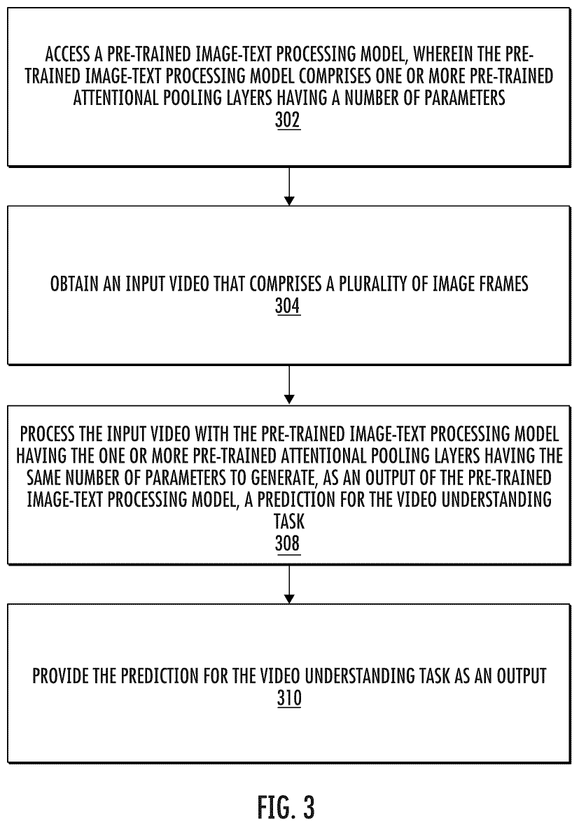

FIG. 3 illustrates a flowchart diagram of an example method for performing a video understanding task with improved computational efficiency.

In block 302, the method begins with the computing system accessing a pre-trained image-text processing model. The image-text processing model can be stored in a memory device or storage medium of the computing system. The image-text processing model can include one or more pre-trained attentional pooling layers with a number of parameters. The image-text processing model may have been pre-trained on a joint contrastive and generative image captioning loss function. For example, the image-text processing model may be the Contrastive Captioners (CoCa) model, which has been pre-trained on a dataset including pairs of images and image captions.

In block 304, the computing system obtains an input video containing a plurality of image frames. The input video could be obtained from various sources such as a user device, a network server, a storage device, a camera, or a video streaming service. The input video can include a sequence of image frames that depict a dynamic scene or event. Each image frame can be a two-dimensional array of pixel values, and the sequence of image frames can represent the temporal evolution of the scene or event.

In block 306, the computing system processes the input video with the pre-trained image-text processing model to generate a prediction for the video understanding task. The processing can involve applying the pre-trained image-text processing model to each image frame of the input video to generate a set of frame embeddings. The frame embeddings can be processed by the pre-trained attentional pooling layers of the image-text processing model to generate a set of generative embeddings and a set of contrastive embeddings. The generative embeddings and contrastive embeddings can be used to generate a prediction for the video understanding task, such as a classification of the video, a response to a question about the video, a caption for the video, or a textual description of the video.

In block 308, the computing system provides the prediction for the video understanding task as an output. The output can be provided to a user, a client device, a server, a database, a display device, or another component of the computing system. The output can be provided in various forms such as a text string, a data file, a database entry, a network message, a display signal, or a sound signal.

The flowchart diagram of FIG. 3 provides a high-level overview of an example method for performing a video understanding task with improved computational efficiency. The method can be implemented by a computing system comprising one or more computing devices. The method leverages a pre-trained image-text processing model to process an input video and generate a prediction for the video understanding task. The pre-trained image-text processing model can include one or more pre-trained attentional pooling layers with a number of parameters. The method can significantly reduce the computational resources required for performing the video understanding task by reusing the parameters of the pre-trained image-text processing model, without requiring the addition of new parameters or extensive re-training.

The method can be applied to various types of video understanding tasks, including video classification, video question answering, video retrieval, and video captioning. The method can be particularly beneficial for applications that require real-time or near-real-time processing of video data, such as video streaming services, video surveillance systems, autonomous driving systems, and interactive gaming systems.

The method can be implemented in various types of computing systems, including personal computers, server computers, mobile devices, cloud computing systems, machine learning platforms, and distributed computing systems. The method can be embodied in various forms, including a software program, a hardware device, a firmware module, a machine learning model, a cloud service, or a combination thereof.

### Example Devices and Systems

FIG. 4A depicts a block diagram of an example computing system 100 that can implement video-text models as described herein according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel video-text processing across multiple instances of video-text inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a video processing service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for performing a video understanding task with improved computational efficiency, the method comprising:
accessing, by a computing system comprising one or more computing devices, a pre-trained image-text processing model, wherein the pre-trained image-text processing model comprises one or more pre-trained attentional pooling layers having a number of parameters, and wherein the pre-trained image-text processing model has been pre-trained on a joint contrastive and generative image captioning loss function;
obtaining, by the computing system, an input video that comprises a plurality of image frames;
processing, by the computing system, the input video with the pre-trained image-text processing model having the one or more pre-trained attentional pooling layers having the same number of parameters to generate, as an output of the pre-trained image-text processing model, a prediction for the video understanding task; and
providing, by the computing system, the prediction for the video understanding task as an output.

2. The computer-implemented method of claim 1, wherein:
the pre-trained image-text processing model comprises a pre-trained unimodal image encoder configured to process an input image to generate one or more frame embeddings;
the one or more pre-trained attentional pooling layers are configured to process the one or more frame embeddings to generate one or more contrastive embeddings and one or more generative embeddings; and
processing, by the computing system, the input video with the pre-trained image-text processing model comprises:
separately processing each of the plurality of image frames with the pre-trained unimodal image encoder to generate a plurality of frame embeddings respectively for the plurality of image frames;
combining the plurality of frame embeddings to form a set of combined frame embeddings; and
processing the set of combined frame embeddings with the one or more attentional layers to generate one or more generative embeddings and one or more contrastive embeddings.

3. The computer-implemented method of claim 2, wherein combining the plurality of frame embeddings to form a set of combined frame embeddings comprises concatenating the plurality of frame embeddings along a temporal dimension to generate a set of flattened frame embeddings.

4. The computer-implemented method of claim 2, wherein combining the plurality of frame embeddings to form a set of combined frame embeddings comprises reshaping the plurality of frame embeddings into a joint space-time representation.

5. The computer-implemented method of claim 1, wherein the parameters of the one or more pre-trained attentional pooling layers of the pre-trained image-text processing model have been held fixed after said pre-training of the pre-trained image-text processing model on the joint contrastive and generative image captioning loss function.

6. The computer-implemented method of claim 5, wherein the video understanding task comprises a zero-shot video understanding task.

7. The computer-implemented method of claim 5, wherein the pre-trained image-text processing model has been trained only on training data comprising only still images.

8. The computer-implemented method of claim 1, wherein an entirety of parameters of the pre-trained image-text processing model have been held fixed after said pre-training of the pre-trained image-text processing model on the joint contrastive and generative image captioning loss function.

9. The computer-implemented method of claim 1, wherein the parameters of the one or more pre-trained attentional pooling layers of the pre-trained image-text processing model have been further finetuned after said pre-training of the pre-trained image-text processing model on the joint contrastive and generative image captioning loss function.

10. The computer-implemented method of claim 9, wherein the parameters of the one or more pre-trained attentional pooling layers of the pre-trained image-text processing model have been further finetuned using the joint contrastive and generative image captioning loss function applied to video data.

11. The computer-implemented method of claim 1, wherein an entirety of parameters of the pre-trained image-text processing model have been further finetuned after said pre-training of the pre-trained image-text processing model on the joint contrastive and generative image captioning loss function.

12. The computer-implemented method of claim 1, wherein:
the pre-trained image-text processing model comprises a pre-trained unimodal image encoder configured to process an input image to generate one or more frame embeddings;
the one or more pre-trained attentional pooling layers are configured to process the one or more frame embeddings to generate one or more contrastive embeddings and one or more generative embeddings;
the pre-trained image-text processing model comprises a pre-trained multimodal decoder configured to process at least the one or more generative embeddings to generate a generative output; and
parameters of the pre-trained unimodal image encoder have been held fixed while parameters of the pre-trained attentional pooling layers and the pre-trained multimodal decoder have been further finetuned using the joint contrastive and generative image captioning loss function applied to video data.

13. The computer-implemented method of claim 1, wherein the one or more pre-trained attentional pooling layers comprise a generative pooling layer configured to generate one or more generative embeddings and a contrastive pooling layer configured to generate one or more contrastive embeddings.

14. The computer-implemented method of claim 1, wherein the method further comprises, prior to processing the input video, appending, by the computing system, an additional encoder model to at least one of the one or more attentional pooling layers.

15. The computer-implemented method of claim 1, wherein the pre-trained image-text processing model comprises a decoder configured to process embeddings generated by the one or more attentional layers to generate a text output.

16. The computer-implemented method of claim 1, wherein the pre-trained image-text processing model further comprises a unimodal text decoder and wherein processing the input video comprises processing a set of input text associated with the input video using the unimodal text decoder.

17. The computer-implemented method of claim 1, wherein the video understanding task comprises a video classification task.

18. The computer-implemented method of claim 1, wherein the video understanding task comprises a video question answering task.

19. The computer-implemented method of claim 1, wherein the video understanding task comprises a video captioning task.

20. One or more non-transitory computer-readable media that collectively store:
a pre-trained image-text processing model, wherein the pre-trained image-text processing model comprises one or more pre-trained attentional pooling layers having a number of parameters, and wherein the pre-trained image-text processing model has been pre-trained on a joint contrastive and generative image captioning loss function; and
computer-executable instructions for perform operations, the operations comprising processing, by the computing system, an input video comprising a plurality of image frames with the pre-trained image-text processing model having the one or more pre-trained attentional pooling layers having the same number of parameters to generate, as an output of the pre-trained image-text processing model, a prediction for a video understanding task.
